(19) United States
(12) Patent Application Publication
(10) Pub. No.: US 2009/0026784 A1
(43) Pub. Date: Jan. 29, 2009

(54) Disassemblable truck rack having gusset and improved bedrail mounting system

(76) Inventor: Christopher Phillip Green, Madera, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 12/284,949

(22) Filed: Sep. 25, 2008

Related U.S. Application Data
(63) Continuation-in-part of application No. 11/644,274, filed on Dec. 22, 2006.
Application No. 11/644,274 is a continuation-in-part of application No. 10/607,964, filed on Jun. 27, 2003.

(51) Int. Cl. B60R 9/06; B60P 3/00; B60R 9/00

(52) U.S. Cl. 296/3; 224/403

(57) ABSTRACT

A rack for pickup trucks configured to carry cargo above the truck bed. The rack is easily installed on and removed from the truck without requiring drilling or other modifications to the truck and is configured to carry heavy loads while utilizing lightweight materials. The rack has a pair of rack assemblies that each comprise a span member, a downwardly disposed engaging member attached to the span member, a leg member engaged at its upper end with the engaging member, a gusset member interconnecting the span, engaging and leg members and an improved clamp assembly to removably secure the rack to the truck bedrails. One span member is partially received in the other span member to form an interconnected span member. Preferably, for added strength, the engaging member is outwardly inclined and configured to be received inside the tubular upper end of the inwardly inclined leg member.

### CROSS-REFERENCE TO RELATED APPLICATIONS

This patent application is a continuation-in-part of U.S. patent application Ser. No. 11/644,274 filed Dec. 22, 2006, which is a continuation-in-part of U.S. patent application Ser. No. 10/607,964 filed Jun. 27, 2003.

### STATEMENT REGARDING FEDERALLY SPONSORED RESEARCH

Not Applicable.

### BACKGROUND OF THE INVENTION

A. Field of the Invention

The field of the present invention relates generally to support racks for pickup trucks and similarly configured vehicles. More particularly, the present invention relates to such truck racks that removably mount to the truck's bedrails without requiring drilling or other modifications to the truck, including the bedrails, and which are disassemblable for ease of installation, removal and shipping. Even more particularly, the present invention relates to such truck racks that have integral gussets and angled support members to better resist load-related forces.

B. Background

As is generally known, many people utilize pickup trucks and similar vehicles for transporting work supplies, sporting equipment and other materials. Although pickup trucks generally have a rear cargo area bed that is suitable to carry a variety of materials, many people prefer to utilize a truck rack to carry some of these materials. The use of a truck rack provides additional carrying capacity for the pickup truck and frees up the rear cargo area to carry larger or heavier weight materials. With regard to carrying certain elongated or oversized materials, such as long ladders, canoes, pipes, lumber or metal, the use of an above-bed rack assembly is almost a necessity to prevent these materials from substantially extending beyond the rear of the vehicle or from being carried in an unbalanced condition. Most truck racks are configured to allow these longer materials to be carried in a manner that extends the materials over the cab portion of the pickup truck.

The prior art discloses a wide variety of truck racks suitable for use with pickup trucks and similar vehicles. The typical pickup truck configured rack comprises a plurality of interconnected frame members that form the frame portion of the rack. Some of the known truck racks utilize frame members that are fixedly connected to each other, such as by welding or riveting, while other racks have frame members that are connected with bolts, screws and other removable connectors. Most known truck racks mount to the pickup truck by mechanisms that require drilling, welding or other modifications to the horizontally displaced load bearing bed and/or the upstanding forward wall, sidewalls and rear tailgate portions of the rear cargo area. Other truck racks utilize various clamping mechanisms to clamp the frame to the pickup truck or utilize connectors that are configured to being received in one or more stake pockets that are commonly disposed on the sidewall bedrails (i.e., the generally shaped, upper most portion of the sidewalls). For the typical truck rack, at least a portion of the frame rests on and is supported by the pickup truck's bedrails. Unfortunately, the placement of frame members on the bedrail interferes with the mounting of tool boxes or other equipment on the bedrails. In addition, because the uppermost edge of many bedrails are not substantially horizontal, the truck rack frame is mounted on the bedrail at an undesirable angle, which can create load bearing and material carrying problems for the truck rack. As a result, in order to resist collapse of the rack and/or dislodging of the rack off the truck due to shearing loads, the typical bedrail mounted truck rack requires heavier weight frame members to provide the necessary support and to safely carry the desired loads. The heavier weight frame members generally require bulky and sophisticated mounting systems and result in a truck rack that is generally difficult for the user to install and remove and expensive for the manufacturer to ship.

A number of prior art patents describe different configurations for pickup truck racks that are adaptable for use to carry various materials, including elongated or oversized materials, above the bed of a pickup truck. For instance, the prior art includes truck racks that are bolted or otherwise attached to a pickup truck with one or more holes drilled in the pickup truck, as exemplified by U.S. Pat. No. 6,557,917 to Colcombe, U.S. Pat. No. 6,513,849 to Carter, U.S. Pat. No. D436,915 to Burger, U.S. Pat. No. 5,002,324 to Griffen and U.S. Pat. No. 4,676,543 to Lewis. The patents to Carter and Lewis also show that it is known to weld a part of the utility rack frame directly to the pickup truck. Each of these patents require modification to the pickup truck, a configuration many pickup truck owners find to be unacceptable. Other prior art pickup truck racks are configured to utilize one or more stake pockets, either to receive a frame member directly into the stake pocket or with the use of stake pocket anchors, as exemplified by U.S. Pat. No. 6,347,731 to Burger, U.S. Pat. No. D444,446 to Carter, U.S. Pat. No. 5,806,905 to Moore, U.S. Pat. No. 5,692,791 to Sulzer, U.S. Pat. No. 5,190,337 to McDaniel, U.S. Pat. No. 4,659,131 to Plournoy, Jr., and U.S. Pat. No. 4,405,170 to Raya. Some of these patents, such as those to Sulzer and Raya, also disclose the use of bolts, with holes drilled into the truck, and clamps to further secure the frame to the truck bedrail. Other patents disclose truck racks that require at least one component to be mounted to the truck bed floor or sidewall, such as U.S. Pat. No. 4,509,787 to Knaack et al., U.S. Pat. No. 4,138,046 to De Freze and U.S. Pat. No. 3,891,262 to Brunel. A few patents, such as U.S. Pat. No. 6,340,106 to Dutton (FIG. 7) and U.S. Pat. No. 5,628,540 to James, disclose the use of clamping members to clamp a portion of the pickup truck frame to the bedrail of the pickup truck.

Although the prior art discloses a number of truck racks for use with pickup trucks and the like, there are certain characteristics of these racks that have generally limited their complete acceptance. For instance, some of these utility racks are not adaptable to different sized rear cargo areas or, if adaptable, only adaptable in a very limited range of sizes. Those truck racks that fixedly mount to the pickup truck substantially reduce the flexibility of the truck owner for utilizing the rear cargo area for certain uses, such as carrying a camper shell or certain sized materials, that require at least temporary removal of the rack from the truck. In addition, the truck racks that have frame members fixedly attached to each other are generally not easy to install on or remove from the pickup truck and are very difficult to ship. Even some of the truck racks that are configured to be taken on and off the pickup truck are not necessarily easy to install or remove, generally due to the size and/or weight of the individual frame members. Those truck racks that rely on engagement with or otherwise use of one or more stake pockets are limited to those pickup trucks that have such components and, when used, foreclose the ability of the pickup truck owner to utilize the stake pocket for other purposes. In addition, as stated above, many of the current methods of securing a truck rack to a pickup truck or other vehicle require the user to drill at least one hole, and typically a plurality of holes, in the truck for receiving a bolt or other connector to mount a portion of the rack to the truck. Unfortunately, this approach to securing a utility rack to a pickup truck has several drawbacks, the primary ones being the effort required to drill holes, having holes in the vehicle and having a utility rack that, even if allegedly removable, is typically not easy to remove. As well known, holes drilled in a vehicle are not easily repaired when the owner no longer desires to use the truck rack or when the pickup truck is to be sold.

What is needed, therefore, is a truck rack for pickup trucks that is disassembable and relatively lightweight for ease of installation, removal, storage and shipping but which has a frame that is configured to carry the desired loads on the truck rack and which removably mounts to the truck without requiring holes be drilled in or other modifications be made to the truck. Preferably, an improved truck rack will be easily adaptable to a relatively wide range of different sized rear cargo areas. In addition, it is desirable that an improved pickup truck rack include a mounting system that quickly, easily and securely mounts the rack to the bedrails of a truck and is suitable for safe and effective use with bedrails which are not horizontal relative to the truck bed. It is also desirable that an improved truck rack have a mounting system which does not interfere with the mounting of tool boxes and other equipment on the bedrails.

### SUMMARY OF THE INVENTION

The truck rack for pickup trucks of the present invention solves the problems and provides the benefits identified above. That is to say, the present invention discloses a disassemblable truck rack which is relatively quick and easy to install on and remove from a pickup truck and relatively easy to store and ship but which is beneficially configured to carry the desired loads on the truck rack. The truck rack of the present invention is adaptable to a wide range of widths and lengths of truck beds to carry a load above the bed of the pickup truck. In the preferred embodiment of the present invention, the truck rack has a mounting system that does not require any holes to be drilled in or other modifications be made to the pickup truck. The truck rack of the present invention, provides a rack which is structurally stronger and more attractive than current truck racks. In addition, the present truck rack allows the user to adjust upward the height of the rack cross-member by inserting a ring of the same cross-sectional dimension as the leg between the upper end of the leg and the cross-member. The mounting system of the preferred embodiment of the truck rack of the present invention is configured for quick and easy installation on the bedrail of a pickup truck and for secure and safe installation thereon. In addition, the preferred mounting system of the present truck rack is suitable for use with pickup trucks that do not have stake pockets in the bedrail or, if they do, for owners who do not want to utilize the stake pockets for the truck rack.

In one aspect of the present invention, the truck rack comprises a first rack assembly and a second rack assembly configured to mount to the bedrails of the opposing sidewalls on a pickup truck. The first rack assembly has an elongated first span member, an engaging member, a leg member, a gusset member and a clamping assembly. The first span member has a first end that is substantially disposed over one of the sidewalls and a second end that extends inwardly above the bed of the truck. The engaging member is attached at one of its ends at or near the first end of the first span member and configured such that it is inclined in a generally downwardly and outwardly direction relative to the first span member. The leg member has a tubular upper end that is sized and configured to receive the lower end of the engaging member therein and a lower end that is attached to a base member which is sized and configured to abut the bedrail of one of the pair of opposing sidewalls. The leg member is inwardly inclined relative to the bedrail so as to receive the engaging member in its upper end so as to provide strength and rigidity to the truck rack. The gusset member has an upper end that is connected to the first span member and a lower end that is connected to the engaging member and to the leg member so as to further strengthen the truck rack. The clamping assembly clamps the base member to the bedrail or to an accessory track provided on certain trucks to support the leg member in generally upstanding relation to the bedrail and to position the first span member in spaced apart relation to the bed of the truck.

The second rack assembly has an elongated second span member, an engaging member, a leg member, a gusset member and a clamping assembly that clamps the rack assembly to the bedrail or to an accessory track provided on certain trucks. The first span member has a first end that extends inwardly above the bed of the truck and a second end that is substantially disposed over the opposing sidewall. The engaging member is attached at one of its ends at or near the second end of the second span member and configured such that it is inclined in a generally downwardly and outwardly direction relative to the second span member. The leg member has a tubular upper end sized and configured to receive the lower end of the engaging member therein and a lower end that is attached to a base member which is sized and configured to abut the bedrail of the opposing sidewall. The leg member is inwardly inclined relative to the bedrail so as to receive the engaging member in its upper end so as to provide strength and rigidity to the truck rack. The gusset member has an upper end that is connected to the second span member and a lower end that is connected to the engaging member and to the leg member so as to further strengthen the truck rack. The clamping assembly clamps the base member to the bedrail or to the accessory track to support the leg member in generally upstanding relation to the bedrail and to position the first span member in above the bed of the truck.

The second end of the first span member and the first end of the second span member are joined together to define an interconnected span member that is supported above the bed of the truck in a generally transverse relationship thereto by the leg member of the first rack assembly and the leg member of the second rack assembly. In one embodiment, the clamping assembly comprises a lower clamp assembly and an upper clamp assembly that cooperate together to clamp the base member to the bedrail. The lower clamp assembly comprises a platform member with an engaging member and an insert member generally upwardly disposed thereon. The engaging member has an upper end configured to engage the underside surface of the bedrail and the insert member has a means for engaging the clamp assembly disposed at the upper end thereof. The upper clamp assembly comprises a channel member that is attached to or integral with the base member. The channel member defines an insert channel which is sized and configured to receive the insert member therein and to engage the engaging means to secure the truck rack to the bedrail. In an alternative embodiment, which is utilized when the truck has an accessory track having a slot therein, the clamping assembly comprises a clamp plate that is configured to be received in the accessory track and one or more connecting elements configured to interconnect the clamp plate and the base member through the slot and through a clamping aperture in the vertical section. The connecting element is engaged with an appropriate connector or with a threaded aperture in the clamp plate to clamp the base member against the accessory track and, therefore, to removably secure the truck rack to the truck.

Accordingly, the primary objective of the present invention is to provide an improved truck rack for pickup trucks and the like that provides the advantages discussed above and that overcomes the disadvantages associated with presently available pickup truck racks.

It is also an important objective of the present invention to provide a truck rack that is easily installed on and removed from pickup trucks having a bed with a peripherally disposed sidewall without requiring drilling into the sidewall or making other modifications to the pickup truck.

It is also an important objective of the present invention to provide a truck rack that is can be quickly and easily disassembled for ease of installing, removing, storing and shipping the truck rack.

It is also an important objective of the present invention to provide a truck rack for pickup trucks that removably attaches to the bedrail of the truck without requiring holes to be drilled into the bedrail and which allows continued utilization of the bedrail to support tool boxes and other equipment.

It is also an important objective of the present invention to provide a truck rack for pickup trucks that is configured to carry the desired loads and resist the load and shear forces from those loads while utilizing relatively lightweight materials for the rack frame components.

It is also an important objective of the present invention to provide a truck rack that is adaptable to a wide range of pickup truck cargo area sizes.

It is also an important objective of the present invention to provide a truck rack that can utilize a variety of different clamping systems to removably clamp a base member of the truck rack onto the bedrail of a pickup truck.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the best modes presently contemplated for carrying out the present invention:

FIG. 1 is a top plan view of a pickup truck having a pair of truck racks that are configured according to a preferred embodiment of the present invention;

FIG. 2 is a rear view from behind the first or forwardly disposed truck rack shown in FIG. 1 showing the truck rack mounted on the bedrails of a pickup truck above a plane disposed between the bedrails and the bed of the rear cargo area;

FIG. 3 is an exploded rear view of the truck of the present invention shown in FIG. 2;

FIG. 4 is a rear view of the left or first span member, gusset and engaging member of the first rack assembly of the truck rack shown in FIG. 3;

FIG. 5 is a rear view of the right or second span member, gusset and engaging member of the second rack assembly of the truck rack shown in FIG. 3;

FIG. 6 is an isolated side view of the first support member and the clamping mechanism of the first rack assembly shown in FIG. 3;

FIG. 7 is an isolated rear view of the second support member and the clamping mechanism of the first rack assembly shown in FIG. 3;

FIG. 8 is a side view of the lower clamp assembly of the clamping mechanism utilized with the truck rack shown in FIGS. 2 and 3;

FIG. 9 is a rear view of the lower clamp assembly shown in FIG. 8;

FIG. 10 is a top view of the lower clamp assembly shown in FIG. 8;

FIG. 11 is an isolated rear view of the lower end of the first rack assembly of the truck rack mounted on the truck showing the clamping mechanism engaged with the bedrail of the truck;

FIG. 12 is a top view of base member utilized with the clamping mechanism of FIG. 11;

FIG. 13 is a top view of an alternative embodiment of the base member showing the channel member having an upper wall with a pair of apertures therein;

FIG. 14 is an isolated rear view of the upper end of an alternative embodiment of the first rack assembly showing use of a spacer member disposed between the upper end of the leg and the first span member;

FIG. 15 is an exploded view of the upper end of the first rack assembly of FIG. 14;

FIG. 16 is an isolated view of the first end of the first span member of FIG. 4 showing the connecting mechanism utilized to connect the first span member and second span member together;

FIG. 17 is a bottom view of the connecting plate of the connecting mechanism shown in FIG. 16;

FIG. 18 is a rear view of an alternative embodiment of the truck rack of the present invention showing use of a tubular engaging member having the upper end of the leg member received therein;

FIG. 19 is a rear view of the first truck rack shown in FIG. 2 showing an alternative embodiment of the clamping mechanism for use with pickup trucks having an accessory track on the bedrail of the truck;

FIG. 20 is an isolated view of the clamping mechanism of FIG. 19;

FIG. 21 is an alternative embodiment of the clamping mechanism configured for use with pickup trucks having an accessory track on the bedrail;

FIG. 22 is a side view of an insert plate utilized with the clamping mechanisms of FIGS. 20 and 21;

FIG. 23 is a rear view of an alternative embodiment of the first truck rack shown utilizing the clamping mechanism of FIG. 2; and

FIG. 24 is an isolated exploded rear view of the second span member and second support member of the first truck rack shown in FIG. 23.

### DETAILED DESCRIPTION OF THE PREFERRED EMBODIMENTS

With reference to the figures where like elements have been given like numerical designations to facilitate the reader's understanding of the present invention, and particularly with reference to the embodiment of the clamp for pickup truck utility racks of the present invention illustrated in the figures, the preferred embodiments of the present invention are set forth below. The enclosed figures and drawings are merely illustrative of the preferred embodiments and represent several different ways of configuring the present invention. Although specific components, materials, configurations and uses of the present invention are illustrated and set forth in this disclosure, it should be understood that a number of variations to the components and to the configuration of those components described herein and in the accompanying figures can be made without changing the scope and function of the invention set forth herein.

A truck rack that is manufactured out of the various components and configured pursuant to the preferred embodiments of the present invention is shown generally as 10 in FIGS. 1 through 3, 14, 19 and 23. As best shown in FIG. 1, the truck rack 10 of the present invention is typically utilized as a pair to form a truck rack system having a first or forwardly disposed rack 10a and a second or rearwardly disposed rack 10b. Typically, racks 10a and 10b will be identically configured as rack 10 of the present invention and, for purposes of the present disclosure, the first rack 10a and second rack 10b are both generally referred to herein as truck rack 10. As known to those skilled in the art, however, in some rack system configurations a person will utilize a different rack in place of either the first 10a or the second 10b rack to cooperate with the remaining rack 10a or 10b. As shown in FIGS. 1 and 2, truck rack 10 generally comprises a first rack assembly 12 and a second rack assembly 14 on the opposite sides of truck 16 having a cab portion 18 and a rear cargo area 20 located rearward of cab portion 18. The rear cargo area 20 has a generally horizontal load bearing bed 22 that is bounded on its periphery by upstanding forward wall 24, tailgate 26 and a pair of opposing sidewalls 28 and 30. As is typical for pickup trucks 16, each of sidewalls 28 and 30 has a bedrail 32 at the top thereof that comprises, as best shown in FIG. 11, a generally planar top surface 34 and an inwardly disposed lip 36. The typical bedrail 32 has one or more stake pockets 38 located thereon. As best shown in FIGS. 1 and 2, first truck rack 10a and second truck rack 10b are positioned on bedrail 32 in spaced apart relationship to each other with first rack assembly 12 and second rack assembly 14 of racks 10a/10b mounted to bedrail 32 of the opposing sidewalls 28 and 30 to support a load, such as ladders, pipe, lumber, canoes and other cargo (not shown), generally above the rear cargo area 20 and cab 18. As will be readily understood by those skilled in the art, first rack 10a and second rack 10b can be moved anywhere along bedrail 32 to change the spacing therebetween and as well as the spacing between first rack 10a and cab 18 and between second rack 10b and tailgate 26 (the rearward end of truck 16) where necessary and/or convenient for the racks 10a/10b to be located so as to best support the desired cargo on truck 16.

In the various embodiments shown in the figures, the truck rack 10 generally comprises a first rack assembly 12 and a second rack assembly 14 that cooperatively join together, as set forth below, to define a single rack 10 with an interconnected span member 40 that is supported above the bed 22 of the truck 16 in a generally transverse relationship to the bed 22 by the components of the first 12 and second 14 rack assemblies, as best shown in FIG. 2. In a preferred embodiment, first rack assembly 12 comprises an elongated first span member 42, an engaging member 44 projecting generally downwardly from said first span member 42, a leg member 46 engaged with the engaging member 44, a gusset member 48 interconnecting the first span member 42, the engaging member 44 and the leg member 46, and a clamping assembly 50 configured to demountably secure leg member 46 to the bedrail 32 of one of the pair of opposing sidewalls, such as first sidewall 28. The first span member 42, best shown in FIGS. 2 through 4, has a first end 52 that is disposed generally above the bedrail 32 of first sidewall 28 and a second end 54 that extends in a direction generally inward from the first sidewall 28 above the bed 22 when truck rack 10 is installed on the truck 16.

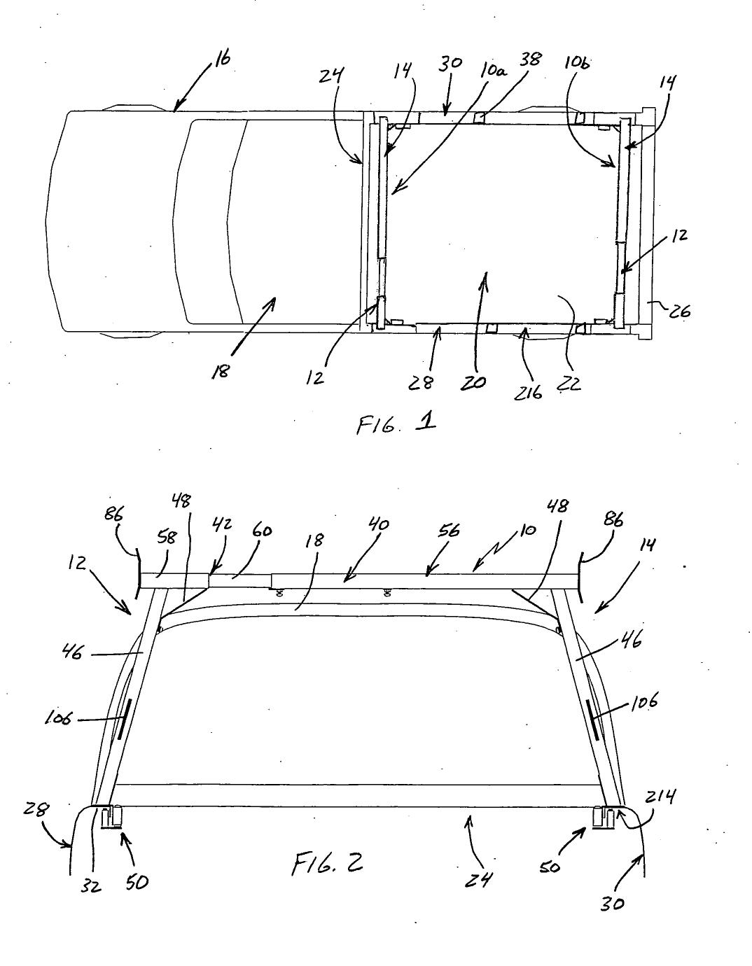

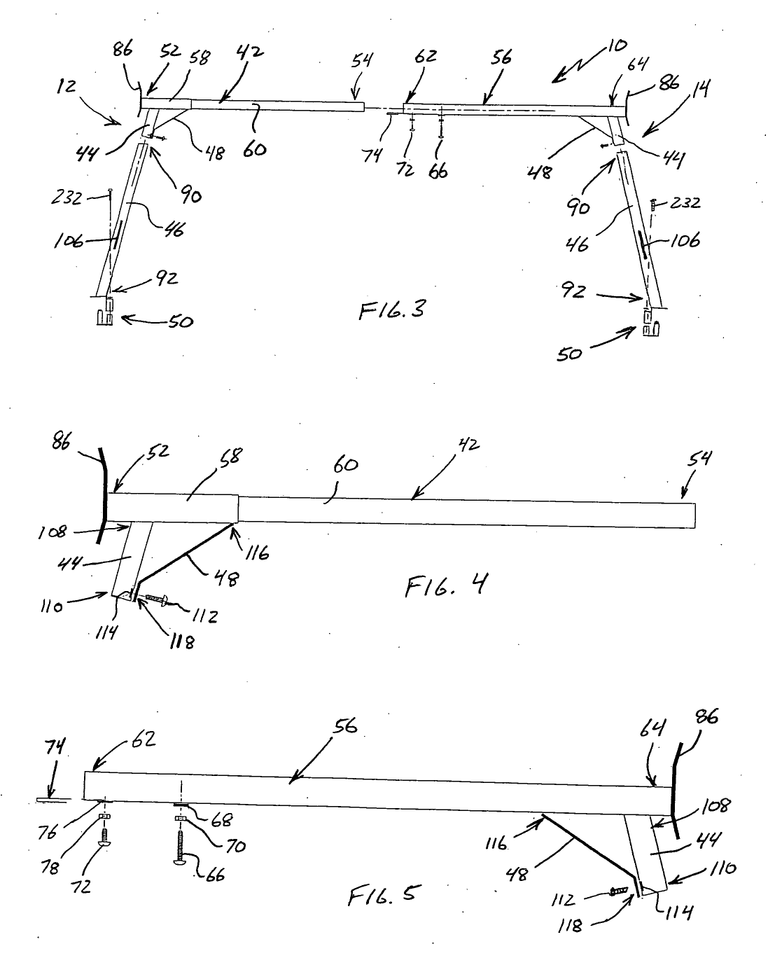

Although truck rack 10 can be configured with a particular, fixed length of interconnected span member 40 to fit a specific width of bed 22, the preferred embodiment of the truck rack 10 of the present invention has the interconnected member 40 configured to be longitudinally adjustable in length so that a single truck rack 10 may be utilized on a variety of different sized pickup trucks 16 having different widths of bed 22 and so that the truck rack 10 may be easily disassembled for ease of installation, removal, storage and shipping. In the preferred embodiment, interconnected span member 40 comprises the first span member 42 and a second span member 56, which is a component of the second rack assembly 14, that cooperate together in a telescoping manner to allow the user to lengthen or shorten the length of interconnected span member 40 to fit different sizes of bed 22. To accomplish the above, the second span member 56 is tubular so that a portion of the first span member 42 is received therein. As best shown in FIG. 4, first span member 42 has a first section 58 generally toward the its first end 52 and a second section 60 generally toward its second end 54, with the second section 54 being sized and configured so that it may be received through the first end 62 of second span member 56 at least enough of a distance to sufficiently interconnect the first 42 and second 56 span members. In a preferred configuration, first span member 42 is a generally square tube with the second section 60 thereof sized and configured to have a smaller cross-section size than the first section 58 thereof and the second span member 56, which is preferably the same size and configuration as first section 58, so that second end 54 and a sufficient amount of second section 60 of firs span member 42 are insertably received in the first end 62 of second span member 56, which is also a generally square tube (although other shapes can be utilized for first span member 42 and second span member 56). Different lengths of interconnected span member 40 for different sized rear cargo areas 20 can be achieved by sliding the second section 60 of the first span member 42 in and out of the second span member 56. If desired, first 42 and second 56 span members can be sized such that the second section 60 of first span member 42 extends inside second span member 56 substantially the entire distance toward second end 64 of second span member 56 when utilized on a small pickup truck 16.

As stated above, in the preferred embodiment both first section 58 and second section 60 of first span member 42 are elongated tubes, with one end of the second section 60 inserted into the adjoining end of the first section 58 and the two pieces welded or otherwise joined together to form a substantially integral first span member 42 from first end 52 to the second end 54 thereof. The second span member 56 is also a tube, having an open first end 62 that is sized and configured to receive the second section 60 of first span member 42 therein to provide the desired telescoping feature. Both first 42 and second 56 span members should be sized and configured to support the desired loads on the truck rack 10 of the present invention. In the preferred embodiment, however, the first 42 and second 56 span members are also selected such that a single person can install and remove truck rack 10 and it may be shipped to the buyer for a reasonable shipping cost.

As known in the art, one or more span connectors, such as a set screw or the like, is utilized to lock first span member 42 to second span member 56 so as to fix the length of interconnected span member 40 for the width of the bed 22, between sidewalls 28 and 30, for the particular truck 16 on which truck rack 10 will be utilized. The use of a set screw, such as set screw 66 in FIG. 5, or the like for a span connector prevents movement of first span member 42 relative to second span member 56 and, as such, reduces vibration of truck rack 10. In one embodiment, a hole is provide in one of the sides of second span member 56 at a position generally towards its first end 62 for set screw 66 to be threadably received through the hole and against the outer surface of second section 60 of first span member 42 such that when the set screw 66 is threaded therein it will push against the outer surface of second section 60 to hold span members 42/56 together. In the preferred embodiment, however, weld nut 68 is fixedly attached to the outer surface of the second span member 56 at the location of the hole and jamb nut 70 is also utilized, with the set screw 66 being sufficiently long to extend through a hole drilled in a wall of second section 60 and abut the inner surface of the opposite wall of second section 60. In this manner, the distal end of the screw 66 will press against the inner surface of the second section 60 to press the outer wall of second section 60 against the inner wall of the second span member 56, thereby holding the first 42 and second 56 span members together without damaging the outer surface of second section 60 of first span member 42 so that it can be moved from one truck 16 to another without the damage, other than the hole, that would otherwise be apparent on the outer surface of second section 60 if the set screw 66 were to abut the outer surface of second section 60. The hole in the second section 60 for receiving the set screw 66 will be located at a position where the interconnected span member 40 is at the proper length for bed 22. Typically, this hole will be drilled by the user of truck rack 10 so that he or she can configure truck rack 10 for his or her truck 16. Alternatively, although likely more difficult with regard to the location, the hole can be pre-drilled by the manufacturer of truck rack 10 for a particular truck 16.

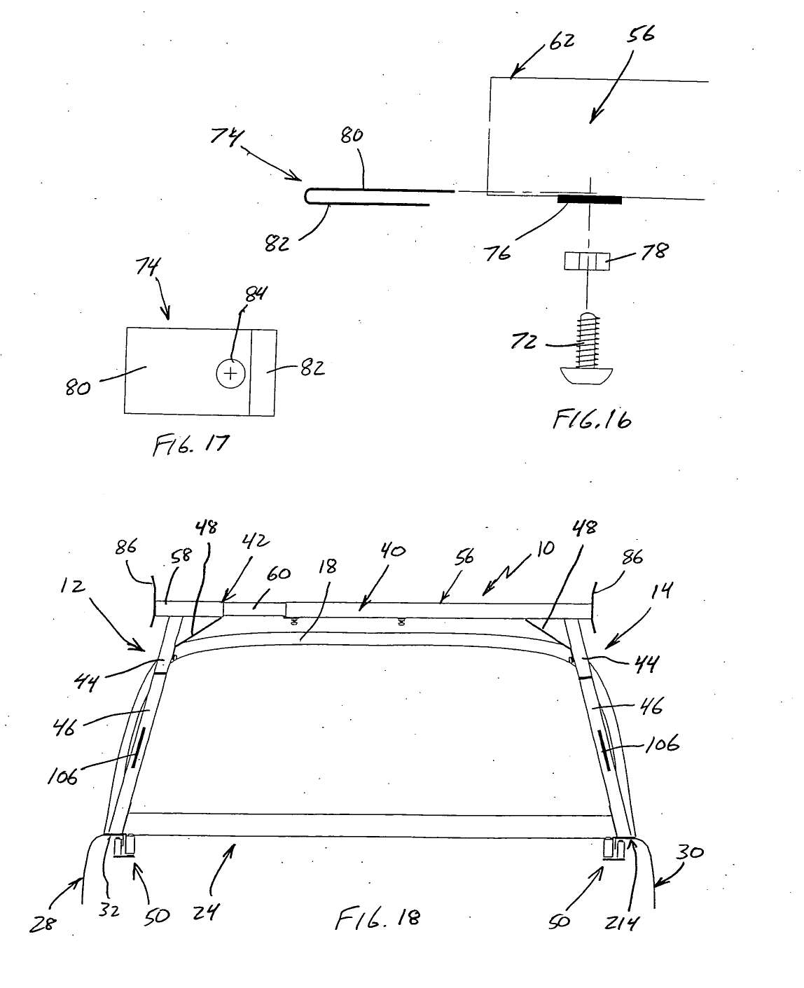

The preferred embodiment of truck rack 10 also includes a second span connecting mechanism, best shown in FIGS. 5, 16 and 17, for securely connecting first 42 and second 56 span members together to form interconnected span member 40. As with the above, a hole is provided in second span member 56 for a set screw, shown as 72. Preferably, the hole for this set screw 72 is provided somewhat closer to the first end 62 of second span member 56, as shown, and a connecting plate 74 is utilized, as well as weld nut 76 and jamb nut 78 (as described above), to clamp the two span members 42/56 together in a manner that does not damage the exterior surface of the second section 60 of the first span member 42. As best shown in FIGS. 16 and 17, connecting plate 74 has a generally U-shaped configuration with a first plate section 80 that is sized and configured to slide into the open first end 62 of second span member 56 and a second plate section 82 that extends on the exterior of the first end 62 of second span member 56. An aperture 84 in the second plate section 82 is configured to be aligned with the hole through which set screw 72 is received. Connecting plate 74 is placed inside the open first end 62 of second span member 56 with the loop interconnecting the first 80 and second 82 plate sections in abutting relation to the end of first end 62 to place aperture 84 over the hole in the second span member 56. When the set screw 72 is threaded through the jamb nut 78 and weld nut 76, it will pass through aperture 84 and press against the first plate section 80, which will be pressed against the exterior surface of second section 60 of first span member 42 without damaging the surface thereof. This will cause the second section 60 of first span member 42 to press against the interior surface of second span member 56, thereby securely connecting the first 42 and second 56 span members together to form the interconnected span member 40 of the size needed for the bed 22 of truck 16.

As noted above and set forth in more detail below, except for the various components of the span members 42/56 and the interconnected span member 40 the components of the first rack assembly 12 and the second rack assembly 14 are the same. The use of the same components, such as engaging members 44, leg members 46, gusset members 48 and clamping assemblies 50, provide interchangeability between the two rack assemblies 12/14 and reduces the cost of manufacturing and reduces the amount inventory that must be kept by a supplier or distributor. Because the components of the assemblies 12/14 are the same, unless otherwise noted, the same numeral designations are utilized for these components to simplify the understanding of the present disclosure.

As stated above, in the preferred embodiment both the first 42 and second 56 span members are tubular for their entire lengths. To close the open ends of the tube, at first end 52 of first span member 42 and at second end 64 of second span member 56 (which are the opposing ends of the interconnected span member 40), the preferred embodiment of truck rack 10 utilizes an ear member 86, best shown in FIGS. 4 and 5, to close the openings and provide certain other benefits for truck rack 10. The ear member 86 can comprise a generally flat, vertically disposed bar that is welded or otherwise fixedly attached to the ends 52 and 64 to close the tubular openings. In a preferred configuration, the ear member 86 projects above the top surface of the interconnected span member 40 to help prevent cargo from falling off of the sides of the truck rack 10 and projects below the bottom surface of the interconnected span member 40 to form a metal loop that can act as an anchor point for hooks or ropes that are used to secure the cargo on truck rack 10. If an ear member 86 is not needed to secure the cargo and provide an anchor point, such as in the embodiment of FIGS. 23 and 24, then a cap, such as the threaded cap member 88, or the like can be utilized instead.

To support the interconnected span member 40 in a generally horizontal position above the bed 22 of truck 16 and to connect to the bedrail 32 of truck 16, the truck rack 10 utilizes a leg member 46 at each of the first rack assembly 12 and second rack assembly 14. As best shown in FIGS. 2 and 3, the leg member 46 of first rack assembly 12 supports first span member 42 and the leg member 46 of second rack assembly 14 supports second span member 56. In the preferred embodiment, leg member 46 is a tube having an open upper end 90 that engages engaging member 44, as set forth in more detail below, and a lower end 92 that attaches to a base member 94 that is configured to abut bedrail 32 to support leg 46 on the sidewalls 28 and 30. To facilitate secure connection of the leg member 46 to the engaging member 48, an aperture 96 is provided in leg member 46 near the upper end 90 thereof. In the preferred embodiment, the base member 94 has a substantially horizontal section 98 that is configured to abut the top surface of the bedrail 32 and a generally vertical section 100 that is configured to abut the inside lip 36 of bedrail 32 when supported by sidewalls 28 and 30, as best shown in FIGS. 6, 7 and 11. As set forth in more detail below, clamping assembly 50 is configured to cooperatively engage the base member 94 to securely attach the truck rack 10 to truck 16 during use of rack 10. In the preferred embodiment, the lower end 92 of leg member 46 fixedly attaches to the base member 94 with support plate 102, which is attached by welding or other means appropriate for the materials utilized, that interconnects the leg member 46 and base member 94. If desired, one or more apertures 104 can be provided in support plate 102 for use to engage hooks, ropes or other cargo supporting devices. In an alternative embodiment, leg member 46 can pivotally attach to one end of the base member 94 so leg member 46 may be folded onto base member 94 for ease of handling, storing and shipping. With leg member 46 substantially folded onto base member 94, the various components of truck rack 10 can fit into a relatively narrow and easy to handle box that reduces shipping costs by fitting within certain size guidelines that have been established by shipping companies. Preferably, leg member 46 also includes one or more tie-down cleats 106, shown in FIGS. 2-3 and 6-7, that are welded or otherwise securely attached to one or more sides of leg member 46, such as the inwardly facing side of leg member 42 shown in the figures, and utilized for looping ropes or other cargo-securing mechanisms.

In one embodiment of the present invention, the leg members 46 are substantially vertical or angled outwardly from side walls 28/30. In the preferred embodiment of truck rack 10 of the present invention, however, the leg members 46 of both the first 12 and second 14 rack assemblies incline inwardly, relative to the generally vertical sidewalls 28 and 30, such that leg members 46 are angled toward each other, as shown in FIGS. 2, 3 and 7, in order to more effectively resist right-to-left horizontal movement (shearing strain). As best shown in FIG. 3, the engaging members 44 extending downwardly from the bottom sides of the first 42 and second 56 span members are cooperatively inclined with the leg members 46 so as to engage the upper ends 90 of the respective leg members 46. In one embodiment, leg members 42 are inclined inwardly approximately fifteen degrees from vertical and engaging members 44 are inclined outwardly approximately fifteen degrees from vertical. As stated above, in the preferred embodiment leg member 42 is tube, or at least the upper end 90 thereof is tubular, to receive its respective engaging member 44 therein.

As best shown in FIGS. 3 through 5, an engaging member 44 extends downwardly from the bottom side of each of the first 42 and second 56 span members. As set forth above, although the engaging members 44 can be configured to extend substantially vertically or inwardly from the span members 42/56, in the preferred embodiment engaging members 44 are inclined outwardly, relative to the substantially vertical sidewalls 28/30, in an angled amount that corresponds to the inwardly angled leg members 42. As also stated above, in the preferred embodiment of truck rack 10, the engaging members 44 are tubular and appropriately sized and configured to be received inside the tubular upper end 90 of leg member 42. Preferably, the upper end 108 of each engaging member 44 is fixedly attached to the bottom side of their respective span member 42/56. With regard to the first span member 42, the upper end 108 of the engaging member 44 is fixedly attached to the first section 58 thereof, as best shown in FIGS. 3 and 4, so as to not interfere with the movement of the second section 60 in and out of the first end 62 of second span member 56. A hole is provided near the lower end 110 of each of the engaging members 44 that is in alignment with aperture 96 near the upper end 90 of the leg members 42 so a connecting element, such as screw 112, can be received therein to secure the engaging member 44 to the upper end 90 of leg members 42. To facilitate the connection, a nut 114 or other connecting element is secured to the inside of engaging member 44 at the hole to threadably receive the screw 112. Various other connecting mechanisms can be utilized to connect each leg member 42 to its respective engaging member 44. Preferably, the components are configured such that the upper end 90 of leg member 42 abuts against the bottom side of their respective span members 42/56, as shown in the FIG. 2.

In an alternative embodiment, shown in FIGS. 14 and 15, the truck rack 10 is configured so the user can quickly and easily adjust the height of interconnected span member 40 without legs 46 being telescoping. As shown in these figures, truck rack 10 includes a spacer member 115 that is configured with the same cross-section as legs 46, but having a typical length of only two to six inches (although shorter or longer lengths can be utilized), to fit between the upper end 90 of leg member 46 and the bottom surface of first 42 or second 56 span members (the first section 58 of first span member 42 shown in the figures). To provide the option of using the spacer member 115, leg member 46 must be provided with or modified to include one or more additional apertures 96 to receive the screw 112 that is utilized to attach the gusset member 48 to the leg member 46 and engaging member 44. In use, the user slides spacer member 115 over engaging member 44, slides upper end 90 of the leg member 46 over engaging member 44 to push spacer member 115 up against the applicable span member 42 or 56, and then attaches the gusset member 48 to leg member 46 and engaging member 44 using screw 112 or other connecting mechanism (as appropriate).

In another alternative embodiment, shown in FIG. 18, the tubular engaging members 44 are cooperatively configured with the upper end 90 of leg members 42 such that the upper end 90 of each leg member 42 is received inside the tubular engaging member 44 (instead of over it, as described above). As with the preferred embodiment, one or more connecting mechanisms are utilized to securely, but removably, attach engaging members 44 to their respective leg member 42. In general, it is believed that most users will not find this configurations as attractive as the preferred embodiment.

As set forth above, truck rack 10 of the present invention includes a gusset member 48 at each of the first 12 and second 14 rack assemblies, as best shown in FIGS. 2 through 5. As shown in these figures, a gusset 48 extends generally downward from each of the first span member 42 and the second span member 56 to their respective leg members 46 so as to interconnect the span members 42/56, leg member 46 and engaging member 44. The purpose of the gusset 48 is to further brace and strengthen the legs 46 and, for a certain strength level, allow lower weight and smaller size components, particularly the first 42 and second 56 span members and leg members 46. In a preferred embodiment, gusset 48 is a generally flat bar that has an upper end 116 which is welded or otherwise fixedly attached to the bottom of the respective first 42 or second 56 span members and a lower end 118 that has a shaped section 120 which is removably attached to the leg member 46 and its associated engaging member 44 with the screw 112, which engages nut 114 inside the engaging member 44. A hole or slot, not shown, in the shaped section 120 is positioned to align with the aperture 96 in leg member 46 and the hole, shown by the nut 114, in engaging member 44. When not connected, the lower end 118 of gusset 48 is in spaced apart relation to the lower end 110 of engaging member 44 so the upper end 90 of leg member 46 can slide between shaped section 120 and the outer surface of gusset 48, as best shown in FIGS. 4 and 5. Typically, this gap only needs to be approximately 0.10 of an inch, depending on the thickness of the wall of the tubular leg member 46. With regard to first span member 42, the upper end 116 of gusset 48 is preferably attached to the first section 58 of first span member 42 (as shown). Preferably, shaped section 120 is configured to be generally parallel to the sides of the engaging member 44 so that it will closely abut the outer surface of leg member 46 when attached with screw 112. In the preferred embodiment, shown in the figures, a single screw 112 is utilized to interconnect the engaging member 44, leg 46 and gusset 48 (and by connection, the span members 42/56), thereby simplifying the installation and removal of truck rack 10 from truck 16. In an alternative embodiment, the upper end 116 of gusset 48 can also be removably attached to the bottom side of the first 42 and second 56 span members utilizing a configuration and connecting elements similar to that used for the lower end 118 of gusset 48.

Various materials and component connection mechanisms can be utilized for the components of truck rack 10. For instance, first 42 and second 56 span members, engaging member 44, leg member 46 and gusset member 48 can be made out of metal, fiberglass, composites, certain plastics and various other materials and various combinations of such materials that have sufficient strength, rigidity, durability and corrosion resistance for truck rack 10 of the present invention. If desired, coated or covered materials can be used to provide the necessary corrosion resistance for its intended use of being exposed to the outside elements. It is necessary that the materials for the above components be selected so as to be sufficiently strong to support the cargo that is desired to be transported on truck rack 10. Likewise, the components and materials selected for clamping assembly 50 must be of sufficient strength, durability and corrosion resistance to provide sufficient clamping force to hold the truck rack 10 on the truck 16 even when fully loaded with cargo. In a preferred embodiment, the primary components for truck rack 10 are made out of metal, such as powder coated steel, stainless steel or aluminum.

As set forth above, a clamping assembly 50 is utilized to securely but removably clamp the truck rack 10 of the present invention to the bedrail 32 of the truck 16. In a preferred embodiment, the clamping assembly 50 is the clamp for truck racks that is disclosed in U.S. patent application Ser. No. 11/644,274, filed by the same inventor on Dec. 22, 2006, the disclosure of which is incorporated in its entirety herein as though fully set forth in the present disclosure. The clamp disclosed in the referenced patent application is configured for use with any type of truck rack that has a base member or like component which extends along a portion of the bedrail 32. The clamp of the above-referenced patent application is a separate component that removably clamps the base member of the rack to the bedrail of a truck. With regard to the present invention, a portion of the clamp disclosed in the above-referenced patent application, primarily the upper clamp assembly, is configured to be integral with the base member 94 of the truck rack 10. Except for the clamping assembly numeral itself, which is 50 herein, the numerals for the clamping assembly 50 are the same, for the same components, as those utilized in the above-referenced patent application.

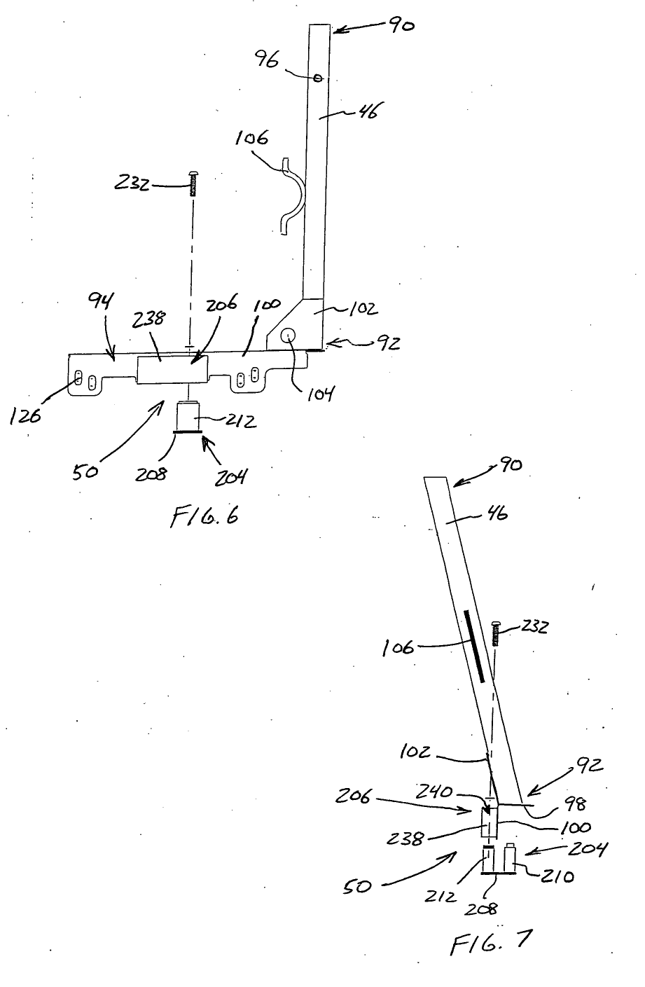

In the preferred embodiment, as shown in FIGS. 2, 3 and 6-13, the clamping assembly 50 generally comprises a generally U-shaped lower clamp assembly 204 and a cooperatively configured upper clamp assembly 206. The lower clamp assembly 204 comprises a platform member 208 having an upwardly extending engaging member 210 and an upwardly extending insert member 212, as best shown in FIGS. 7 through 10. As set forth in more detail below, engaging member 210 is configured to engage the underside surface 214, best shown in FIGS. 2 and 11, of top surface 34 of bedrail 32 and insert member 212 is sized and configured to engage upper clamp assembly 206 when clamp 50 is utilized to securely mount truck rack 10 onto the top surface 34 of bedrail 32. As best shown in FIGS. 8-10, platform member 208 is a generally planar member having a first end 218, a second end 220 and an upwardly facing upper surface 222, with engaging member 210 disposed on upper surface 222 at or near the first end 218 and insert member 212 disposed on upper surface 222 at or near the second end 220 thereof. As shown, engaging member 210 and insert member 212 are in spaced apart relation in order to prevent contact between bedrail 32 and lower clamp assembly 204, except at the upper end 224 of insert member 212 (as described below). Platform member 208, engaging member 210 and insert member 212 should be manufactured out of metal or other materials having suitable strength, rigidity and corrosion resistance for the intended outdoor use on pickup truck 16 or be coated or treated with material, such as powder coating, to provide the desired corrosion resistance. Engaging member 210 and insert member 212 can be tubular or solid members. In one embodiment, platform member 208, engaging member 210 and insert member 212 are separate components that are suitably joined together, such as by welding or the like, to define a single, lower clamp assembly 204. Alternatively, the platform member 208, engaging member 210 and insert member 212 components can be integrally manufactured using processes well known to those skilled in the art of such manufacturing.

In a preferred embodiment, as best shown in FIGS. 7 and 9, the upper end 224 of engaging member 210 is provided with cushioning member 226 that is configured to abut the underside surface 214 of the top surface 34 of bedrail 32 in manner that substantially prevents damage to underside surface 214. As known to those familiar with pickup trucks 16, bedrail 32 thereon is made out of metal that is painted to match the rest of pickup truck 16. Cushioning member 226 is selected so as to prevent or at least substantially reduce the likelihood of damage thereto from the upper end 224 of engaging member 210. In a preferred embodiment, lower cushioning member 226 is a slightly compressible material, such as hard rubber or the like, that prevents damage to underside surface 214 by preventing the upper end 224 of engaging member 210 from contacting the underside surface 214. A variety of other materials may also be suitable for the cushioning member 226.

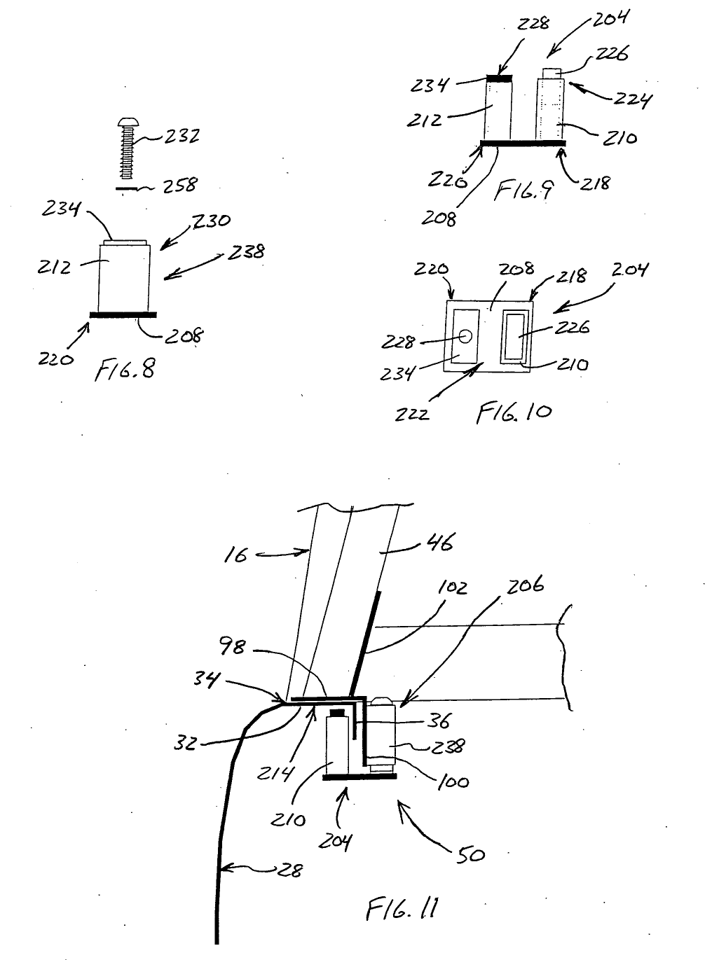

Insert member 212 of lower clamp assembly 204 is configured for use with a means for engaging clamping assembly 50 that connects insert member 212 with upper clamp assembly 206 so as to secure truck rack 10 to bedrail 32 of pickup truck 16. In a preferred embodiment, the engaging means is a threaded aperture 228 at the upper end 230 of insert member 212, as best shown in FIG. 10, sized and configured to receive a like threaded screw 232. If insert member 212 is a solid component, then the threaded aperture 228 can be disposed therein. If insert member 212 is a tubular component, then threaded aperture 228 can provided in a top portion of the tube. The screw 232 and the components of lower clamp assembly 204 are configured such that when the screw 232 is inserted into threaded aperture 228 from the top it will draw the lower clamp assembly 204 upward to simultaneously engage the upper clamp assembly 206 and the underside 214 of the bedrail 32 to clamp the truck rack 10 to the bedrail 32 of the truck 16, as best shown in FIG. 11. In a preferred embodiment, shown in the figures, insert member 212 is tubular and threaded aperture 228 is provided by a cap plate 234, such as a weld nut that is welded onto or otherwise fixedly attached to the upper end 230 of insert member 212, at the upper end 230 of insert member 212. As is apparent to those skilled in the art, various alternative mechanisms can be utilized to join lower clamp assembly 204 to upper clamp assembly 206 than the threaded aperture 228 and screw 232 described above and shown in the figures. Any such mechanism should be chosen to be able to securely, but removably, join lower 204 and upper 206 clamp assemblies to allow the user to easily and quickly install truck rack 202 onto truck 16 or remove it therefrom as he or she may require or desire.

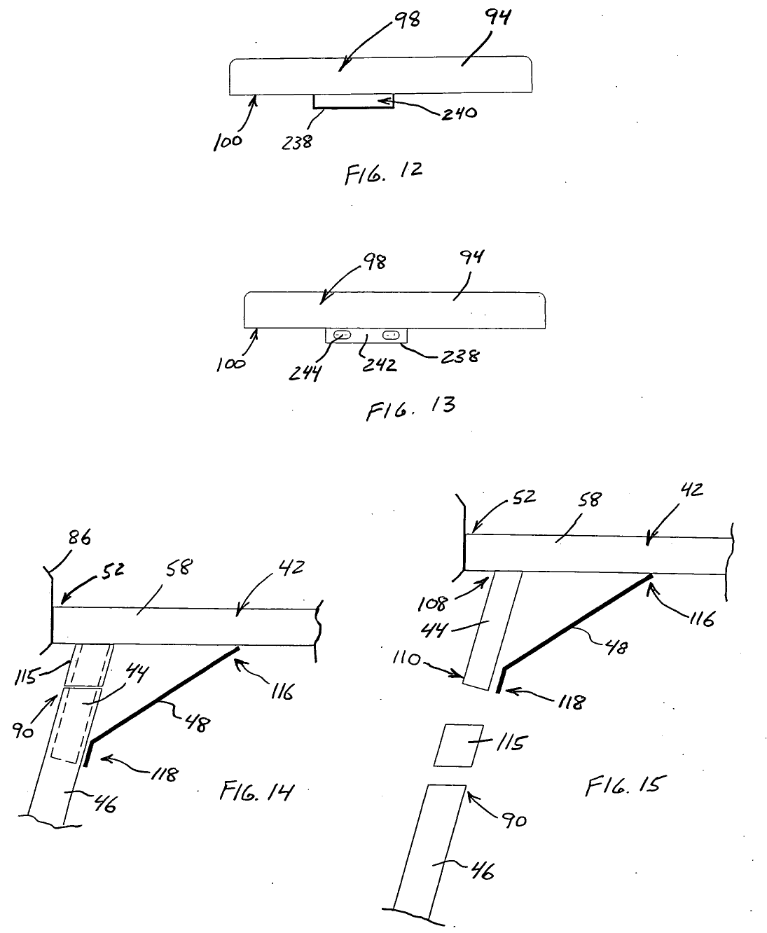

In the preferred configuration of clamping assembly 50, upper clamp assembly 206 comprises a channel member 238 that is fixedly attached to base member 94 so as to define an insert channel 240, as best shown in FIG. 12, to receive insert member 212 therein. In one embodiment, insert channel 240 is sized and configured such that insert member 212 is slidably received therein to allow insert member 212 to move at least somewhat freely relative to insert channel 240 in the direction of base member 94. The size of insert member 212 and insert channel 240 should be selected such that the two components cannot rotate relative to each other, or at least have very limited rotation, and for only limited lateral movement to each other. Because insert member 212 is slidably received in insert channel 240, as best shown in FIG. 11, the lower clamp assembly 204 may move horizontally relative to the channel member 238 of upper clamp assembly 206, inside insert channel 240, so the user can easily adjust the location of lower clamp assembly 204 in light of any obstruction that may be present under bedrail 32. A specially configured washer or other member sized to span between the channel member 238 and the vertical section 100 of base member 96, having an aperture therein to receive screw 232, can be utilized at the top of the insert channel for the screw 232 to engage against to provide the necessary clamping between the lower 204 and upper 206 clamp assemblies. In an alternative embodiment, shown in FIG. 13, channel member 238 has a top wall 242 to engage screw 232 with one or more apertures 244 therein to receive screw 232 so that it may threadably engage the insert member 212 to clamp the lower 204 and upper 206 clamp assemblies together. As with the components of lower clamp assembly 204, channel member 238 of upper clamp assembly 206 should be manufactured out of metal or other materials having suitable strength, rigidity and corrosion resistance for the intended outdoor use on pickup truck 16 or which may be coated or treated with another material, such as by powder coating, to provide the desired corrosion resistance. In one embodiment, channel member 238 is fixedly attached, such as by welding or the like, to vertical section 100 of base member 94 to define the upper clamp assembly 206. Alternatively, channel member 238 can be integrally manufactured with the base member 94.

In one configuration of clamping assembly 50 of the truck rack 10 of the present invention, channel member 238 is a generally C-shaped component that is fixedly attached (i.e., by welding) to the side of the vertical section 100 that is disposed inside rear cargo area 20 of truck 16 when truck rack 10 is installed on truck 16, as best shown in FIGS. 2 and 7, with insert channel 240 disposed between the inner side of vertical section 100 and channel member 238, as best shown in FIG. 12. As set forth above, insert member 212 is removably received in the insert channel 240 defined by channel member 238. In this configuration, vertical section 100 of base member 94 will be disposed between the engaging member 210 and the insert member 212, as best shown in FIGS. 2 and 7. When in use, as shown in FIGS. 2 and 11, cushioning member 226 at the upper end 224 of engaging member 210 will be against the underside 214 of bedrail 32. Depending on the strength of materials and connections used for clamping assembly 50, one advantage of this embodiment of clamping mechanism 50 is that the portion of insert channel 240 not occupied by insert member 212 can be utilized as a tie-down location. If the materials and/or connections are not configured with sufficient strength to be used as a tie-down, then the user of truck rack 10 should be warned not to use this space for tying down the cargo as such use could result in damage to the truck rack 10, truck 16 and/or the cargo being carried on rack 10 and possible injury to the user and/or others.

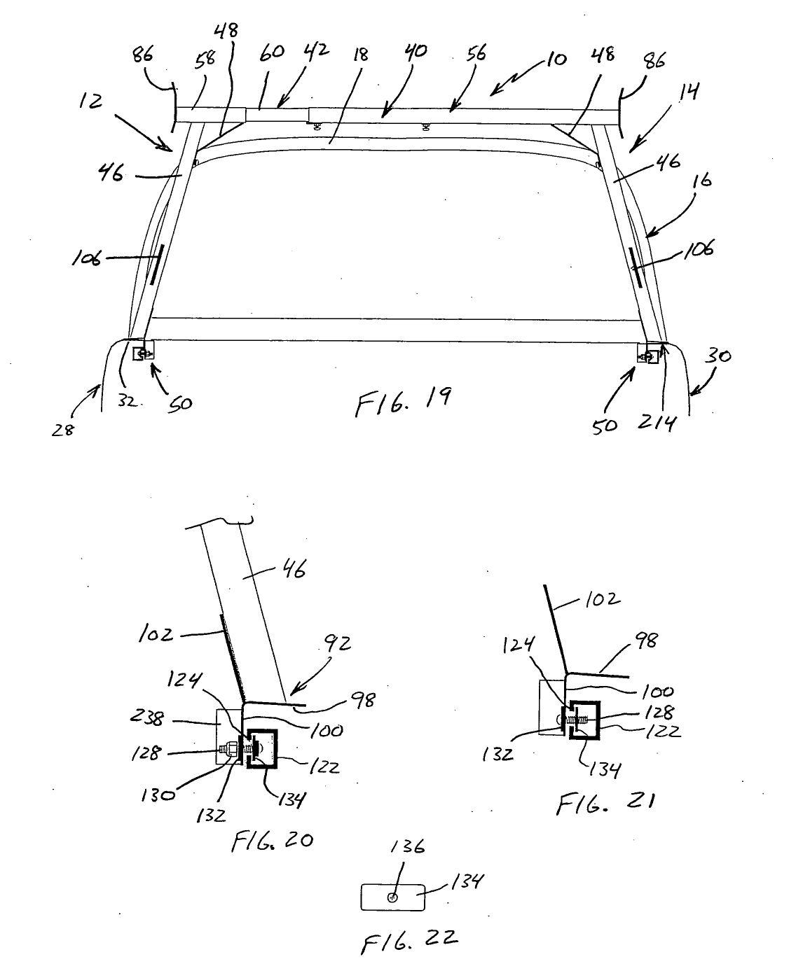

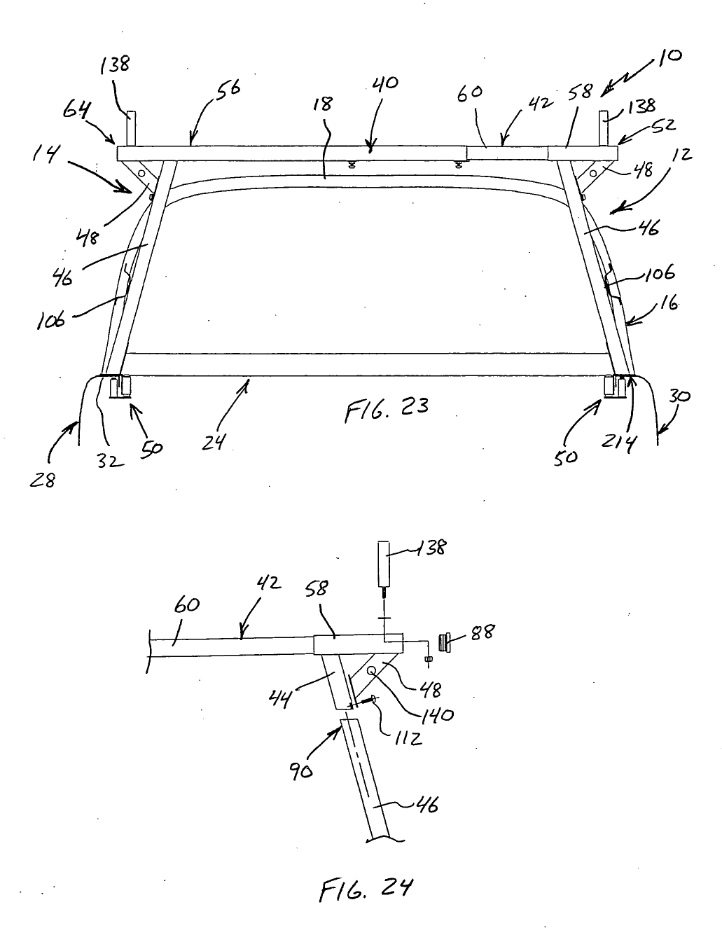

In an alternative configuration of clamping assembly 50 used with truck rack 10 of the present invention, shown in FIGS. 19 through 22, the truck rack 10 is configured to be secured to the truck 16 by utilizing the accessory track 122 that is provided by the manufacturer for some models of trucks 16. These accessory tracks 122 are provided with a slot 124 facing inward to rear cargo area 20 and are configured to be utilized with various accessory items, such as cleats, eye hooks and the like. For the present invention, the accessory track 122 and slots 124 therein are utilized with base member 94 to secure the first 12 and second 14 rack assemblies of truck rack 10 onto the bedrail 32 of the sidewalls 28 and 30, as best shown in FIG. 19. To facilitate such use, base member 94 is provided with one or more clamping apertures 126, shown in FIG. 6, that are cooperatively positioned with slot 124 such that they are generally aligned when horizontal section 98 and vertical section 100 of base member 94 are in abutting relation to the top surface 34 and lip 36 of bedrail 32. The clamping assembly 50 of this embodiment additionally comprises a threaded bolt 128 that is sized and configured to extend through slot 124, a lock nut 130 that is threadably received on bolt 128, one or more washers 132 and a clamp plate 134 having an aperture 136, as shown in FIG. 20, though which the bolt 128 passes. In the embodiment of FIG. 20, the bolt 128 is inserted through the aperture 136 of plate 134 and then the plate 134 is inserted into accessory track 122 with the bolt 128 extending out of the track 122 toward the rear cargo area 20 and through one of the clamping apertures 126. The washer 132 and then the nut 130 are placed over the bolt 128 and the nut is threadably secured to the bolt 128 to draw the clamp plate 134 against the interior wall of the track 122 by slot 124 and the vertical section 100 of the base member 94 against the outer wall of the track 122 at the slot 124 to secure the truck rack 10 to the bedrail 32. In the embodiment of FIG. 21, the clamp plate 134 is placed inside the accessory track 122 and the bolt 128 is placed through one of the clamping apertures 126 in vertical section 100 of base plate 94, with washer 132 therebetween, to pass through aperture 136 in clamp plate 134. In the preferred embodiment of this configuration, bolt 128 threadably engages a threaded aperture 136, thereby eliminating the need to utilize nut 130. When bolt 128 is engaged, vertical section 100 of base plate 94 will be pressed against the accessory track 122 to securely mount truck rack 10 to truck 16.

Although the foregoing description includes threaded screw 232 and bolt 128 as the connecting mechanisms to clamp the lower 204 and upper 206 clamp assemblies together or attach to accessory track 122 when securing the base member 94 of truck rack 10 to the bedrail 32 of pickup truck 16, a variety of other connecting mechanisms can be utilized instead of screw 232 or bolt 128, including various other types of screws, bolts and other connectors that are likely to suffice for clamping assembly 50 of the present invention. In a preferred embodiment, any such connecting mechanism includes some type of security feature to at least make it difficult for unauthorized persons to disengage clamping assembly 50 and remove truck rack 10 from pickup truck 16. In a preferred embodiment, with threaded screw 232 or bolt 128 as the connecting mechanism, a security feature is incorporated into the drive opening of the head of screw 232 or bolt 128. The security feature can be as simple as a Torx® or similar type of less common drive opening, compared to slotted or Phillips heads, that reduces the likelihood that a potential thief will be able to easily remove truck rack 10 from pickup truck 16. For additional security, the security feature can be selected to require the use of a specially configured driver that is not readily available to the public or the use of a custom made, proprietary driver that is not available to the public at all. As known in the art, tamper resistant screws and bolts utilize specially designed drive openings, some of which may include one or more upwardly extending pins therein for additional security, that can only be engaged by a cooperatively configured bit which is supplied to the user when ordering the screws or bolts. Many of the designs for the security feature are proprietary, such that only the user is supplied with the driver bits that fit the drive opening of threaded screw 232 or bolt 128. Use of such proprietary features can essentially make clamping assembly 50 tamper proof. With a tamper resistant security feature incorporated into screw 232 or bolt 128, the user can be relatively confident that an unauthorized persons will not be able to disengage clamping assembly 50 to remove truck rack 10 from pickup truck 16.

An alternative embodiment of the truck rack 10 of the present invention is shown in FIGS. 23 and 24. In this embodiment, the open tubular ends of the interconnected span member 40, which are the first end 52 of first span member 42 and the second end 64 of second span member 56, are closed with cap 88, as shown in the exploded view of FIG. 24, instead of an ear member 86. To help keep the load on top of the truck rack 10, without the upper portion of the ear member 86 being available, this embodiment utilizes a nut tube 138 that is attached to the top surface of each span member 42/56 near the respective ends 52 and 64 thereof. In the preferred embodiment, nut tube 138 is removably connected to span members 42/56 for ease of storage and shipping and to allow variations to the size of this component based on the user's needs. To assist with securing the cargo on truck rack 10, an aperture 140 is provided in gusset member 48, as best shown in FIG. 24, to be utilized with ropes or other tie-down members. The gusset member 48 in this embodiment is a tubular member that is positioned on the side of truck rack 10 opposite that shown in the previous embodiments, in a position that generally connects leg member 46 with ends 52 and 64 of the respective span members 42/56. As with the other embodiments, the tubular upper end 90 of leg member 46 slides over the engaging member 44 to abut the bottom surface of the respective span members 42/56 and a screw or bolt 112 is utilized to interconnect the engaging member 44, leg member 46 and gusset member 48. The interconnected span member 40 and the clamping assembly 50, utilizing the U-shaped lower clamp assembly 204, are the same as that set forth above for the previously described embodiments.

A variety of other alternative embodiments can be configured for the truck rack 10 of the present invention. For instance, the interconnected span member 40 can comprise a center tubular span member that receives or is received in the ends of the first 42 and second 56 span members that are then connected using a connecting element. The leg members 42 can be configured as a single tubular member, as shown, or leg members 42 can comprise two or more components that are joined together to form leg members 42 to further reduce the cost of shipping and allow variations in the size of truck rack 10. If desired, the components for leg members 42 can be telescopically configured so the user can adjust the height of the truck rack 10 for his or her truck 16. Other configurations for the engaging members 44 and gusset member 48 can also be utilized with truck rack 10 of the present invention. Likewise, clamping assembly 50 can be modifications of the two embodiments described above or other types of clamping assemblies can be utilized to secure truck rack 10 to truck 16.

In use, the user will assemble truck rack 10 by inserting the upper end 90 of leg member 46 over the lower end 110 of engaging member 44 until the upper end 90 of leg member 46 abuts the bottom side of each of the first 42 and second 56 span members and then inserting screw 112 through the hole or slot at the lower end 118 of gusset 48 to threadably engage the nut 114 inside the tubular lower end 110 of engaging member 44 to secure the leg 46 to the span members 42/56. The user then insets the second section 60 of the first span member 42 into the tubular first end 62 of the second span member 56 to form the interconnected span member 40 and utilize screws 66 and 72 to secure the two span members 42/56 together. The user then places the base members 94 of each of the first 12 and second 14 rack assemblies onto the bedrails 32 of the sidewalls 28 and 30, with the horizontal section 98 resting on the top surface 34 of bedrail 32 and the vertical section 100 against lip 36 of bedrail 32, to position the interconnected span member 40 above the bed 22 of truck 16. For truck 16 having conventional bedrails 32, the user will utilize the U-shaped lower clamp assembly 204 to secure truck rack 10 to truck 16 by inserting the insert member 212 inside the insert channel 240 of channel member 238 and positioning the engaging member 210, having cushioning member 226, such that it is under the underside 214 of bedrail 32. When the screw 232 is threaded into aperture 228, cushioning member 226 is pressed against the underside 214 of bedrail 32 and horizontal section 98 of base member 94 is clamped against the top surface 34 of bedrail 32 to secure truck rack 10 to truck 16. For trucks 16 having an accessory track 122, the user places the clamp plate 134 inside the track with the threaded end of bolt 128 extending through aperture 136 in clamp plate 134 and outward through the slot 124 of the accessory track 122 into rear cargo area 20, passing through one of the clamping apertures 126 in the base member 94. The user then places a washer 132 over the bolt 128 and threads the nut 130 onto the bolt 128 to clamp the base member 94 to the accessory track 122 to secure the truck rack 10 to the truck 16. Alternatively, the bolt 128 is placed through one of the clamping apertures 126 of base member 94, through slot 124 and into the accessory track 122 where it threadably engages the aperture 136 in clamp plate 134 to clamp the vertical section 100 of base member 94 against the accessory track 122 to secure the truck rack 10 to the truck 16. Removal of truck rack 10 from truck 16 is accomplished by generally reversing the installation steps set forth above.

As will be readily apparent to those skilled in the art, the truck rack 10 of the present invention has numerous advantages over prior art truck racks, including the ability to quickly and easily assemble the truck rack 10 on the truck and to disassemble the truck rack 10 into relatively small, easy to handle, store and ship components. The configuration of truck rack 10, particularly the use of the inclined engaging members 44 and that connect to the cooperatively inclined leg members 46 and the use of a gusset member 48 to connect span members 42/56 to their respective engaging member 44 and leg member 46, allows the user to carry heavy loads while allowing the manufacturer to utilize lightweight materials for the components of the truck rack 10. The junction of the span member 42/56, engaging member 44, leg member 46 and gusset member 48 provides corners which are independently stable for the truck rack 10. Only a few screws, bolts or other connecting elements are required to connect the various components into truck rack 10. The integrated clamping assembly 50 allows use of truck rack 10 with trucks 16 having conventional bedrails 32 and sidewalls with accessory tracks 122. The U-shaped lower clamp assembly 204 removably clamps truck rack 10 to the to the bedrails 32 without utilizing the stake pockets 38 or requiring any holes or other modifications to be made to the bedrails 32. Use of the clamp plate 134 inside the accessory track 122 provides a quick and easy to use clamping system for those trucks 16 that have such accessory tracks 122. The preferred clamping assemblies 50 are compact so as to not interfere with ropes or other cargo securing devices and resist being knocked loose by any movement of the cargo. The clamping assemblies do not interfere with the use of tool boxes or other accessories that sit on the bedrail 32 of the truck 16. The use of the double set screws 66 and 72, one of which penetrates the span members 42/56 and one which engages a connecting plate 74, securely joins these two components together in a manner that does not damage the finish on the span members 42/56. The use of the ear members 86 helps secure the cargo on truck rack 10 and provides loops below the horizontal plane of integrated span member 40 for attaching hooks and/or loops. One benefit of truck rack 10 is that it can be quickly and easily moved from one truck 16 to another 16 for use thereon.

While there are shown and described herein certain specific alternative forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to the dimensional relationships set forth herein and modifications in assembly, materials, size, shape and use.

What is claimed is:

1. A truck rack for a pickup truck having a rear cargo area with a bed and a pair of opposing generally vertical sidewalls each having a bedrail at the top thereof, said truck rack comprising:
a first rack assembly having an elongated first span member with a first end and a second end, a downwardly projecting engaging member disposed at or near said first end of said first span member, a leg member having an upper end at said engaging member and a lower end, a gusset member interconnecting said first span member, said engaging member and said leg member, and a clamping assembly clamping said base member to the bedrail or to an accessory track attached to the truck so as to support said leg member in generally upstanding relation to the bedrail to position said first span member in spaced apart relation to the bed of the truck; and
a second rack assembly having an elongated second span member with a first end and a second end, a downwardly projecting engaging member at or near said second end of said span member, a leg member having an upper end at said engaging member and a lower end, a gusset member interconnecting said second span member, said engaging member and said leg member, and a clamping assembly clamping said base member to the bedrail or to an accessory track attached to the truck so as to support said leg member in generally upstanding relation to the bedrail to position said first span member in spaced apart relation to the bed of the truck,
wherein said second end of said first span member and said first end of said second span member are joined together to define an interconnected span member supported above said bed in a generally transverse relationship thereto by said leg member of said first rack assembly and said leg member of said second rack assembly.

2. The truck rack according to claim 1, wherein said engaging member of said first rack assembly has a first end at said first span member and an opposing second end sized and configured to interconnect with said upper end of said leg member, said engaging member of said second rack assembly has a first end at said second span member and an opposing second end sized and configured to interconnect with said upper end of said leg member.

3. The truck rack according to claim 2, wherein said engaging member of each of said first rack assembly and said second rack assembly are sized and configured to be substantially received in said upper end of said leg member of said respective first or second rack assembly.

4. The truck rack according to claim 2, wherein said upper end of said leg of each of said first rack assembly and said second rack assembly are sized and configured to be substantially received in said engaging member of said respective first or second rack assembly.

5. The truck rack according to claim 1, wherein said second end of said first span member is sized and configured to be received in said first end of said second span member, said truck rack further comprising a connecting plate disposed between said first span member and said second span member and one or more connecting elements configured to engage said connecting plate to clamp said first span member and said second span member together so as to define said interconnected span member.

6. The truck rack according to claim 1, wherein each of said engaging members are inclined relative to the sidewalls of the truck and each of said legs are cooperatively inclined with said respective engaging member.

7. The truck rack according to claim 6, wherein each of said engaging members are inclined generally outwardly and each of said leg members are inclined generally inwardly relative to the sidewalls of the truck.

8. The truck rack according to claim 7, wherein said engaging member of each of said first rack assembly and said second rack assembly are sized and configured to be substantially received in said upper end of said leg member of said respective first or second rack assembly.

9. The truck rack according to claim 1 further comprising a base member at said lower end of each of said leg members, said clamping assembly configured to clamp said base member to its respective sidewall.

10. The truck rack according to claim 10, wherein said clamping assembly comprises a lower clamp assembly and an upper clamp assembly, said lower clamp assembly having a platform member with an engaging member and an insert member generally upwardly disposed thereon, said engaging member having an upper end configured to engage an underside surface of the bedrail, said insert member having means for engaging said clamp assembly disposed at an upper end thereof.

11. The truck rack according to claim 11, wherein said upper clamp assembly comprises a channel member attached to or integral with said base member, said channel member defining an insert channel sized and configured to receive said insert member therein and to engage said engaging means so as to secure said truck rack to the bedrail.

12. The truck rack according to claim 9, wherein said base member has a substantially horizontal section sized and configured to abut a top surface of said bedrail and a substantially vertical section sized and configured to simultaneously abut a lip of said bedrail.

13. The truck rack according to claim 12, wherein said vertical section of said base member has one or more clamping apertures configured to receive a connecting element of said clamping assembly to secure said truck rack to said truck.

14. The truck rack according to claim 13, wherein said truck has an accessory track having a slot therein, said clamping assembly comprising a clamp plate configured to be received in said accessory track, said connecting element configured to interconnect said clamp plate and said base member through said slot and through one of said one or more clamping apertures.

15. A truck rack for a pickup truck having a rear cargo area with a bed and a pair of opposing generally vertical sidewalls each having a bedrail at the top thereof, said truck rack comprising:
a first rack assembly having an elongated first span member with a first end and a second end, a downwardly projecting engaging member disposed at or near said first end of said first span member, a leg member having a tubular upper end sized and configured to receive said engaging member therein and a lower end attached to a base member sized and configured to abut the bedrail of one of the pair of opposing sidewalls, a gusset member having an upper end connected to said first span member and a lower end connected to said engaging member and said leg member, and a clamping assembly clamping said base member to the bedrail or to an accessory track attached to the truck so as to support said leg member in generally upstanding relation to the bedrail to position said first span member in spaced apart relation to the bed of the truck; and
a second rack assembly having an elongated second span member with a first end and a second end, a downwardly projecting engaging member at or near said second end of said span member, a leg member having a tubular upper end sized and configured to receive said engaging member therein and a lower end attached to a base member sized and configured to abut the bedrail of the other of the pair of opposing sidewalls, a gusset member having an upper end connected to said second span member and a lower end connected to said engaging member and said leg member, and a clamping assembly clamping said base member to the bedrail or to an accessory track attached to the truck so as to support said leg member in generally upstanding relation to the bedrail to position said first span member in spaced apart relation to the bed of the truck,
wherein said second end of said first span member and said first end of said second span member are joined together to define an interconnected span member supported above said bed in a generally transverse relationship thereto by said leg member of said first rack assembly and said leg member of said second rack assembly.

16. The truck rack according to claim 15, wherein each of said engaging members are inclined relative to the sidewalls of the truck and each of said legs are cooperatively inclined with said respective engaging member.

17. The truck rack according to claim 16, wherein each of said engaging members are inclined generally outwardly and each of said leg members are inclined generally inwardly relative to the sidewalls of the truck.

18. The truck rack according to claim 17, wherein said clamping assembly comprises a lower clamp assembly and an upper clamp assembly, said lower clamp assembly having a platform member with an engaging member and an insert member generally upwardly disposed thereon, said engaging member having an upper end configured to engage an underside surface of said bedrail, said insert member having means for engaging said clamp assembly disposed at an upper end thereof, said upper clamp assembly having a channel member attached to or integral with said base member, said channel member defining an insert channel sized and configured to receive said insert member therein and to engage said engaging means so as to secure said truck rack to said bedrail.

19. The truck rack according to claim 17, wherein truck has an accessory track having a slot therein and said base member has a substantially horizontal section sized and configured to abut a top surface of said bedrail and a substantially vertical section sized and configured to simultaneously abut a lip of said bedrail, said vertical section having one or more clamping apertures, said clamping assembly comprising a clamp plate configured to be received in said accessory track and one or more connecting elements configured to interconnect said clamp plate and said base member through said slot and through one of said one or more clamping apertures to removably secure said truck rack to said truck.

20. A truck rack for a pickup truck having a rear cargo area with a bed and a pair of opposing generally vertical sidewalls each having a bedrail at the top thereof, said truck rack comprising:
a first rack assembly having an elongated first span member with a first end and a second end, a downwardly and outwardly inclined engaging member disposed at or near said first end of said first span member, an inwardly inclined leg member having a tubular upper end sized and configured to receive said engaging member therein and a lower end attached to a base member sized and configured to abut the bedrail of one of the pair of opposing sidewalls, a gusset member having an upper end connected to said first span member and a lower end connected to said engaging member and said leg member, and a clamping assembly clamping said base member to the bedrail or to an accessory track attached to the truck so as to support said leg member in generally upstanding relation to the bedrail to position said first span member in spaced apart relation to the bed of the truck; and
a second rack assembly having an elongated second span member with a first end and a second end, a downwardly and outwardly inclined engaging member at or near said second end of said span member, an inwardly inclined leg member having a tubular upper end sized and configured to receive said engaging member therein and a lower end attached to a base member sized and configured to abut the bedrail of the other of the pair of opposing sidewalls, a gusset member having an upper end connected to said second span member and a lower end connected to said engaging member and said leg member, and a clamping assembly clamping said base member to the bedrail or to an accessory track attached to the truck so as to support said leg member in generally upstanding relation to the bedrail to position said first span member in spaced apart relation to the bed of the truck,
wherein said second end of said first span member and said first end of said second span member are joined together to define an interconnected span member supported above said bed in a generally transverse relationship thereto by said leg member of said first rack assembly and said leg member of said second rack assembly.
